(19) United States
(12) Patent Application Publication
(10) Pub. No.: US 2017/0321814 A1
(43) Pub. Date: Nov. 9, 2017

(54) ROTARY VALVE AND QUICK EXHAUST VALVE FOR RAILWAY VEHICLE

(71) Applicant: KITZ CORPORATION, Chiba (JP)

(72) Inventors: Kazuhiro AOKI, Nagano (JP); Hiroki OHNO, Nagano (JP)

(73) Assignee: KITZ CORPORATION, Chiba (JP)

(21) Appl. No.: 15/533,577

(22) PCT Filed: Dec. 9, 2015
(86) PCT No.: PCT/JP2015/084508

§ 371 Date: Jun. 6, 2017

(30) Foreign Application Priority Data
Dec. 11, 2014 (JP) 2014-251224

(51) Int. Cl. F16K 11/085; F16K 31/60; B61D 19/00

(52) U.S. Cl. CPC F16K 11/0856; F16K 31/602; B61D 19/00

(57) ABSTRACT

A rotary valve and a quick exhaust valve for a railway vehicle in which high sealability and operability at the time of valve opening and closing are ensured. Outflow/inflow ports (10, 11) and a discharge port (12) are formed in a valve body accommodating part having a spherical surface part or a tapered surface part formed on part of an inner periphery in a body (2), and a valve body (3) is rotatably inserted from an opening which is open from the valve body accommodating part. A spherically-shaped surface part or a tapered-shaped surface part is formed at a position opposing the spherical surface part or the tapered surface part, a plurality of through ports communicating the outflow/inflow ports or the discharge port and an attachment groove opposing the outflow/inflow ports in a direction crossing the through ports are formed, and a seal member is attached to the attachment groove.

### TECHNICAL FIELD

The present invention relates to a rotary valve with ensured sealability at the time of opening and closing a flow path and with reduced operation torque at the time of valve operation, and an exhaust valve provided by this rotary valve structure, the exhaust valve being a quick exhaust valve for a railway vehicle for use in, for example, piping of an automatic door opening/closing apparatus or the like using air pressure in a railway vehicle and provided for exhausting in-cylinder air pressure of the door opening/closing apparatus by an air-pressure piston cylinder by operation to close a flow path of a conduit on an air pressure supply side.

### BACKGROUND ART

Conventionally, for example, in an automatic door opening/closing apparatus using air pressure in a railway vehicle, to manually open and close a door in case of emergency, repair, maintenance inspection, or the like, a quick exhaust valve for a railway vehicle for releasing pressure air for automatic door operation is generally used. As this exhaust valve, a ball valve having a substantially spherically-shaped valve body is normally used often. In the ball valve of this type, since a flow path of the valve body forms a circular through hole, a flow at the time of full opening does not have an obstacle; a pressure loss is small, compared with a glove valve or butterfly valve; and, unlike a gate valve, a stroke of a stem is not required, and thus the valve can be made compact.

Also, for opening and closing a flow path in a railway vehicle, a stopcock may be used. Normally, in the stopcock, a metal-made valve body in a convex cone shape is accommodated in a metal-made body machined in a concave cone shape and, when the valve body rotates with respect to the body, a fluid is sealed by mutual sealing of opposing metal sealing parts.

On the other hand, PTL 1 discloses a ball valve including a case having a hemispherically-shaped hollow space, a plug, and a seal member. The plug is integrally formed by a hemispherically-shaped valve body and a valve shaft, and can rotate about the valve shaft by fitting in the hollow hemispherical space of the case. The hemi spherically-shaped valve body of the plug has a concave part formed therein, and the seal member is attached to fit in this concave part.

A ball valve of PTL 2 includes a valve box, a hemispherically-shaped valve body of an integral type with a stem, and a seal member which seals a sliding surface of this valve body so as to make close contact with and cover the sliding surface. In a cavity of the valve box, the seal member is attached. To this seal member, the valve body is attached. In this ball valve, the structure is such that the entire outer circumference of the valve body is sealed by the seal member.

The above-described ball valves are classified into a floating type and a trunnion type. The above-described PTL 1 and PTL 2 disclose floating-type ball valves. In this ball valve, the structure is such that the valve body is supported by the seal member and sealing is made by a differential pressure at the time of full closing to push to a seat member on a secondary side. On the other hand, a trunnion-type ball valve has a structure in which a ball valve body is supported by a stem and a trunnion (lower stem).

Also, a rotary valve of PTL 3 has a structure in which, in a body having formed therein a valve body accommodating part with an inner circumferential hemispherical surface, with screw attachment between a male screw part and a female screw part, a valve body rotates in a valve closing direction as descending to put a seal member to an outflow/inflow port for hermetically sealing.

### CITATION LIST

### Patent Literatures

PTL 1: Japanese Patent Application Laid-Open Publication No. 9-79391

PTL 2: German Utility Model Registration No. 9408156

PTL 3: Japanese Patent Application Laid-Open Publication No. 2012-2355

### SUMMARY OF INVENTION

### Technical Problem

In the case of the above-described ball valve having a substantially spherically-shaped valve body, to enhance sealability to prevent leakage while reducing operation torque to enhance operability, it is required to assemble so that contact pressure between seat members on primary and secondary sides and the valve body is uniform. To satisfy this, it is required to machine, with high accuracy, the surfaces of the seat members on a seal side, the spherical surface of the valve body, and seal surfaces of an attaching part on a body side where these members are attached and so forth, and then assemble these components. In particular, in the ball valve of this type, a contact area between the seat members and the valve body is changed in the course of rotation of the valve body, and unevenness tends to occur in operation torque. Therefore, it is difficult to ensure stable operability.

After assembling, the seat members oppose from the primary and secondary sides to be always attached with strong pressure, and therefore tend to be abraded. In particular, the floating-type ball valve has a structure in which the valve body presses and seals the seat member on one side (secondary side) by fluid pressure in a concentrated manner and the pressing force of the seat member on one side (primary side) is decreased. Therefore, uneven abrasion of the seat member increases when the pressure increases and, as a result, durability of the seat member is low, and replacement may be required, and therefore economic efficiency is also low. On the other hand, the trunnion-type ball valve has a structure of preventing movement of the valve body by the lower stem and reducing abrasion of the seat member. However, complication of the inner structure leads to an increase in cost. These ball valves have also problems of a large number of components, a requirement of improving machining accuracy, and a large number of assembling processes.

When a fluid flows, fluid resistance increases on inflow/outflow port sides at the time of slight opening of these ball valves, and cavitation tends to occur. Here, the structure is such that, after passing through a subtle opening between the valve body and the seat member on the primary side, the fluid passes through a communication hole between a large-volume body cavity and the valve body and again flows a subtle opening between the valve body and the seat member on the secondary side. Thus, an orifice portion is formed in two steps, and an energy loss is large. Furthermore, at the time of half opening, since the cavity volume is large, a loss factor when the fluid flows is also increased, and flow resistance is also increased. At the time of full opening, there is also a problem in which an increase in temperature of the sealed fluid building up inside the large-volume cavity causes an abnormal pressure rising to damage and deform the seat member to cause leakage and defective operation.

In the case of the stopcock, the structure is such that the body and the valve body are provided by metal and the flow path is opened and closed by mutual sealing of metal sealing parts of these body and valve body each formed in a tapered shape. Thus, tapering of these, lapping of the valve body and the body, and grease coating process are performed, and processing on the seal surface requires high accuracy. At the time of use, grease is lost with its use, and therefore grease coating is also regularly required and frequent maintenance is required to be performed.

In the ball valve of PTL 1, since the hemispherically-shaped valve body and seal member are mounted so as to fit in the hollow hemispherical space in a hemispherical shape, a pressure contact force of the seal member is intensified, as with the above-described ball valve having a substantially spherically-shaped valve body. Also, the protruding seal member slides as being in a state of interfering with an edge part of the outflow/inflow port, thereby degrading durability of the seal member.

The ball valve of PTL 2 has a structure in which the entire outer periphery of the valve body is sealed by a large seal member attached in the cavity of the valve box. Therefore, when the seal member is abraded, this seal member as a whole is required to be replaced, and economic efficiency is degraded.

In the rotary valve of PTL 3, the seal member makes contact with the body only at the time of valve closing. Therefore, operation torque can be reduced. However, when the seal member is abraded, the valve body is further screwed to descend. Therefore, the seal member is shifted from the position of the outflow/inflow port, and the position of the lid member is required to be adjusted as required.

The present invention was developed to solve the above-described problems, and has an object of providing a rotary valve in which high sealability and operability at the time of valve opening and closing are ensured, the rotary valve in which economic efficiency is also excellent while durability is improved with a simple structure and degradation of a valve body and a seal member by a fluid and a loss at the time of outflow and inflow of the fluid are minimized, and a quick exhaust valve for a railway vehicle.

### Solution to Problem

To achieve the object described above, the invention according to claim 1 is directed to a rotary valve in which outflow/inflow ports and a discharge port are formed in a valve body accommodating part having a spherical surface part or a tapered surface part formed on part of an inner periphery in a body, a valve body is rotatably inserted from an opening which is open from the valve body accommodating part, a spherically-shaped surface part or a tapered-shaped surface part is formed on an outer periphery of this valve body at a position opposing the spherical surface part or the tapered surface part, a plurality of through ports communicating the outflow/inflow ports or the discharge port and an attachment groove opposing the outflow/inflow ports in a direction crossing these through ports are further formed, a seal member for closing the outflow/inflow ports or the discharge port is attached to this attachment groove, any one of the outflow/inflow ports or the discharge port is hermetically sealed and closed by the seal member when the opening is covered with a lid member, the outflow/inflow port and the discharge port or the outflow/inflow ports are provided so as to be able to communicate mutually via the through ports, also a retaining ring is interposed between a lower inner circumferential surface of the valve body accommodating part and a lower outer circumferential surface of the valve body, and this retaining ring is attached between the valve body and the lid member.

The invention according to claim 2 is directed to the rotary valve wherein a spring member is attached between the lid member and the valve body, the seal member can be additionally tightened by the lid member covering the opening, and the seal member is provided so as to be able to be pressed on a seal surface of the body via the spring member.

The invention according to claim 3 is directed to the rotary valve wherein the rotary valve is provided so that the outflow/inflow ports and the discharge port are connected to a conduit so as to allow a flow path of this conduit to be switched or allow a fluid to be discharged from the discharge port.

The invention according to claim 4 is directed to the rotary valve wherein a seating face part is provided to one or both of front and back surfaces of the body, and a protruding part which regulates a grasp from the front and back surfaces sides of the body is formed on at least one side on this seating face part.

The invention according to claim 5 is directed to a quick exhaust valve for a railway vehicle wherein an exhaust time for exhausting air from an automatic door opening/closing apparatus piping in case of emergency, security, or the like can be set constant by adjusting the discharge port area of the rotary valve.

### Advantageous Effects of Invention

From the invention according to claim 1, a pressure loss is small, compared with a globe valve, butterfly valve, and so forth. Unlike a gate valve, a stroke of a stem is not required, and the valve can be made compact. Unlike a ball valve and stopcock, without machining the sealing surface of the valve body, the seal member, or the like with high accuracy, high sealability and operability at the time of opening and closing the valve body can be both achieved. With the outflow/inflow port or the discharge port closed by one seal member, durability of this seal member can be improved while operation torque is suppressed low, and high sealability can be kept over a long period of time by suppressing abrasion. Since the structure is simple and the number of components is small, economic efficiency is excellent, and assembling, maintenance at the time of replacing the seal member, and so forth are easy.

To let the fluid flow, while cavitation is suppressed at the time of slight opening, an energy loss at this time of slight opening can be minimized. At the time of full opening, a loss factor is decreased by the outflow/inflow ports, thereby allowing flow resistance to be suppressed. Furthermore, with a small cavity volume, an abnormal pressure rising value can be suppressed low, and therefore an occurrence of leakage and defective operation can be avoided. In this manner, a loss at the time of outflow/inflow of the fluid is minimized to enhance functionality as a valve, and the fluid can be let flow with smooth operation compared with the ball valve. From these, while drawbacks of the ball valve are solved, it is possible to provide a rotary valve having advantages of the ball valve, thestopcock, and so forth integrated therein. Also, the retaining ring is interposed between the lower bottom surface part of the valve body and the upper surface of the lid member, and center adjustment of the axial center of the spherical-surface-shaped seal surface of the body and the axial center of rotation of the valve is ensured on inner and outer diameter sides of the retaining ring, and an occurrence of an imbalance of the surface pressure of the seal member by fluid pressure is avoided. With this, when the valve body is pressed to a body side, the outflow/inflow ports or the discharge port is hermetically-sealed and closed by the seal member, while a predetermined crush margin is kept, stable sealability is kept with a predetermined seal surface pressure, and valve opening and closing operability and sealing performance can be improved.

The retaining ring exerts functions of a radial bearing and a thrust bearing. By the function of the radial bearing, falling of the valve body when the seal member is fastened is prevented, and abrasion and galling of the valve body shaft with the falling of the valve body are prevented. On the other hand, by the function of the thrust bearing, the crush margin with elasticity of the material of the seal member is kept, and stress mitigation and creeping can be prevented.

From the invention according to claim 2, the valve body is pressured by the spring member to allow a predetermined seal surface pressure to act on the seal member. By additional fastening of the lid member, this seal surface pressure can be adjusted to be constant. By adjusting the seal surface pressure of the seal member, operation torque is suppressed low and smooth operation is ensured. Also, with the pressing of this seal member, the outflow/inflow ports or the discharge port can be hermetically sealed and closed. Furthermore, even in the case of changes in dimension due to expansion or shrinkage with friction with sliding of the sealing member and temperature changes by environmental temperature, the seal surface pressure is ensured to be constant by the resilient force of the spring member to prevent leakage. In this state, when the flow path is switched, with compression of the valve body by the spring member, torque characteristics and sealability are both achieved even, in particular, at the time of low temperatures, the valve is resistant also to vibrations, and valve seat sealability, that is, a friction force between the seal member and a valve seat side, is also kept even if the valve is used at a location with a lot of vibrations. A valve open state due to natural loosening of the valve body can be prevented.

From the invention according to claim 3, with one valve, opening and closing and switching the flow path and fluid discharge are performed. By providing this to part of the conduit, while unnecessary valves, tee joints, elbow joints and so forth are omitted to reduce the number of components, a simplified conduit can be configured, and locations to be operated can also be reduced. Thus, opening and closing and switching of the flow path and discharge operation are also simplified.

From the invention according to claim 4, the protruding part is formed on the seating face part provided to the body. With this, to hold the body with a vise or cramp, the protruding part abuts to cause unstable fastening, and it is possible to reliably prevent the seating face part from being held. With this, piping can be connected while deformation of the body is prevented, accuracy of the seal part on the inner circumferential surface of the body is kept to cause the seal member of the valve body to accurately abut on this seal part, and seal leakage and external leakage of the fluid can be reliably prevented.

From the invention according to claim 5, while the valve body is inserted in the valve body accommodating part to ensure compactability as a whole, the flow path diameter is increased to a full-bore diameter. With this, a large flow rate at the time of switching the flow path and a large displacement volume at the time of exhaust can be ensured. In accordance with the exhaust time changing with the piping location, the discharge port area is adjusted, and the exhaust time can be suppressed to a certain short time. Thus, pressure air in the automatic door opening/closing apparatus for a railway vehicle can be quickly exhausted to allow the automatic door to be manually operated, and a time from a time when the valve is operated to a time when the automatic door is manually operated is shortened, thereby allowing quick handling in case of emergency, security, or the like. By providing the body as a one-piece structure, loosening of components at the time of piping operation is eliminated, and air leakage from the piping can be reliably prevented. While the entire size is reduced, the number of components is decreased, and arrangement is possible even inside the railway vehicle or an external narrow installation space.

### BRIEF DESCRIPTION OF DRAWINGS

FIG. 1 is a perspective view depicting a first embodiment of a rotary valve of the present invention.

FIG. 2 is a longitudinal sectional view of the rotary valve of FIG. 1.

FIG. 3 is a longitudinal sectional view depicting a valve closed state of the rotary valve of FIG. 2.

FIGS. 4(a), 4(b), and 4(c) are sectional views each depicting a rotation state of the valve in the first embodiment.

FIG. 5 is an enlarged sectional view of main parts depicting a state in which the valve of FIG. 4 rotates.

FIG. 6 is a circuit diagram depicting a state in which the rotary valve of FIG. 1 is connected to piping.

FIG. 7 is a general schematic view depicting a state in which a quick exhaust valve for a railway vehicle is used for a railway vehicle.

FIG. 8 is a longitudinal sectional view depicting a second embodiment of the rotary valve in the present invention.

FIG. 9 is a longitudinal sectional view depicting a valve body in FIG. 8.

FIG. 10 is a partially-enlarged sectional view depicting another example of a seal member.

FIG. 11 is a perspective view depicting a third embodiment of the rotary valve in the present invention.

FIG. 12 is a lateral sectional view of the rotary valve of FIG. 11.

FIG. 13 is a partially-omitted longitudinal sectional view of the rotary valve of FIG. 11.

### REFERENCE SIGNS LIST

1, 130 valve main body

2 body

3 valve body

4 lid member

5, 140 seal member

6 disc spring (spring member)

10, 11 outflow/inflow port

12 discharge port

15 spherical surface part

16 valve body accommodating part

22 opening (lower inner circumferential surface)

28 spherically-shaped surface part

30, 31, 32 through port

33 attachment groove

80 conduit

100 automatic door opening/closing apparatus

131 tapered surface part

132 tapered-shaped surface part

141 retaining ring

152 lower outer circumferential surface

162 seating face part

170 protruding part

S discharge port area

### Description of Embodiments

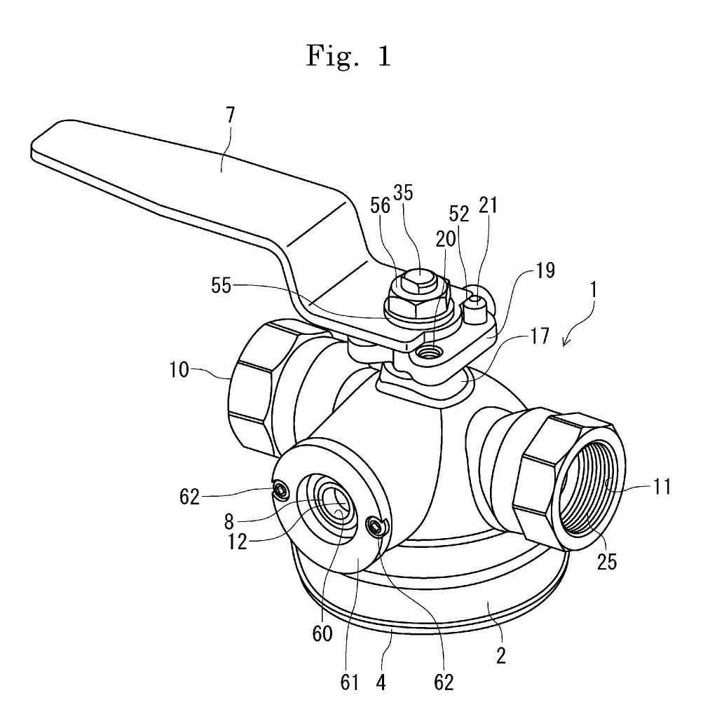

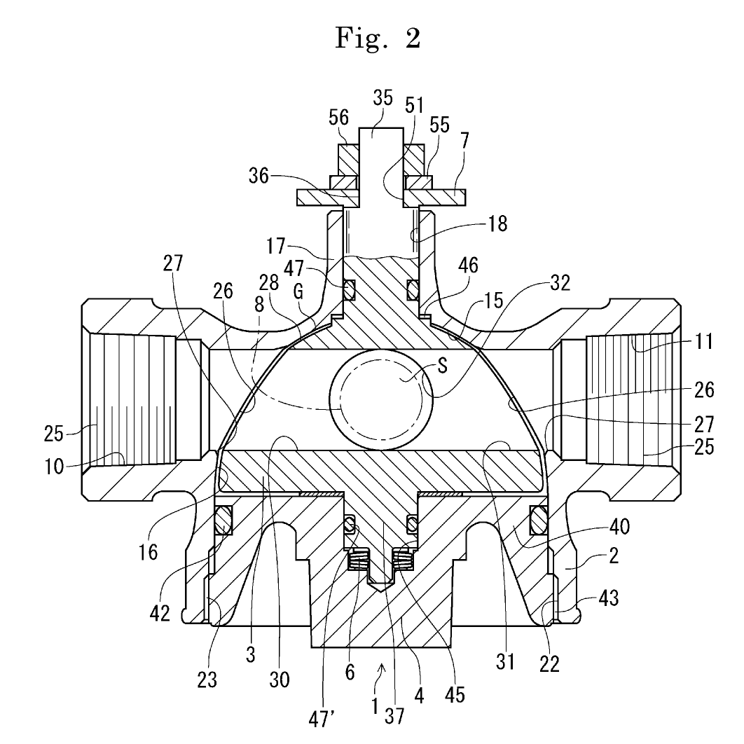

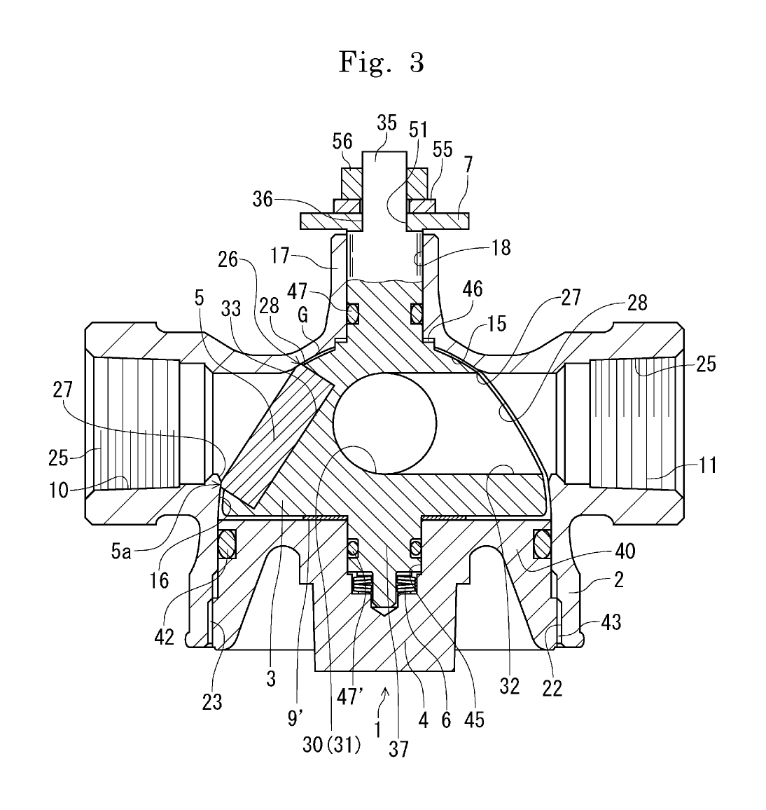

In the following, embodiments of the rotary valve and quick exhaust valve for a railway vehicle in the present invention are described in detail based on the drawings. In FIG. 1, a perspective view of a first embodiment of the rotary valve in the present invention is depicted. In FIG. 2, a longitudinal sectional view of the rotary valve of FIG. 1 is depicted. In FIG. 3, a valve closed state of the rotary valve is depicted. The rotary valve (hereinafter referred to as a valve main body 1) of the present invention has a body 2, a valve body 3, a lid member 4, a seal member 5, a spring member 6, and a handle 7.

In FIG. 1, the body 2 of the valve main body 1 is formed of a material, for example, such as bronze, brass, or stainless steel, in a one-piece structure, has outflow/inflow ports 10 and 11 and a discharge port 12 crossing these outflow/inflow ports 10 and 11. In the present example, the discharge port 12 is formed with a spacing of 90° between the outflow/inflow ports 10 and 11 in series in two direction. With this overall structure of the body 2, the valve main body 1 is provided so that piping can be made in a state in which the orientation of the discharge port 12 can be reversed at 180° by switching the orientations of the two outflow/inflow ports 10 and

In part of an inner periphery inside the body 2, a valve body accommodating part 16 having a spherical surface part or a tapered surface part is formed. In the present embodiment, the valve body accommodating part 16 with a spherical surface part 15 formed therein is provided in part of the body 2. On upper side of this valve body accommodating part 16, a shaft inserting part 17 is provided. In this shaft inserting part 17, an insertion hole 18 is provided. On an upper part of the shaft inserting part 17, a flange part 19 is formed. In this flange part 19, mounting holes 20 are formed at four locations at a spacing of 90°. In any one of these mounting holes 20, an engagement pin 21 is put by, for example, press-fitting or screw-in. On a lower inner circumferential side of the valve body accommodating part 16, a cylindrical opening 22 is formed so as to be provided to extend. In this opening 22, a female screw 23 is provided. The spherical surface part 15 is provided in a substantially hemispherical recessed shape by counter boring process in a substantially hemispherical shape.

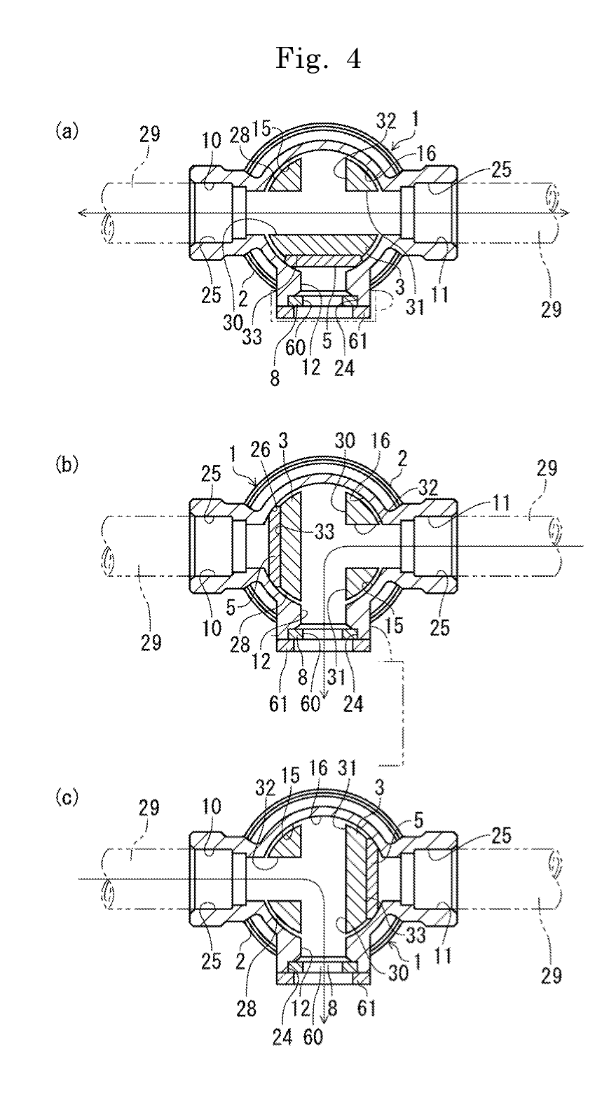

In FIG. 4(a) to FIG. 4(c), the above-described discharge port 12 has a substantially same diameter as that of the outflow/inflow ports 10 and 11, and is formed in a state of communicating with the valve body accommodating part 16 together with these outflow/inflow ports 10 and 11. The discharge port 12 is formed so as to penetrate, with a diameter of, for example, φ12 mm. On the periphery of this discharge port 12 on a discharge side, a counter-bored part 24 on the order of φ15 mm is machined and formed. On the other hand, on the inner peripheral side of the outflow/inflow ports 10 and 11, a screw-engagement part 25, which is a female screw with a pipe-purpose tapered screw of ⅜ inches is formed. Via this screw-engagement part 25, a pipe 29 is provided so as to be connectable to the outflow/inflow ports 10 and 11. While the counter-bored part 24 is formed in the discharge port 12 in the present embodiment, this discharge port 12 may be provided in a shape having a screw-engagement part similar to the outflow/inflow ports 10 and 11.

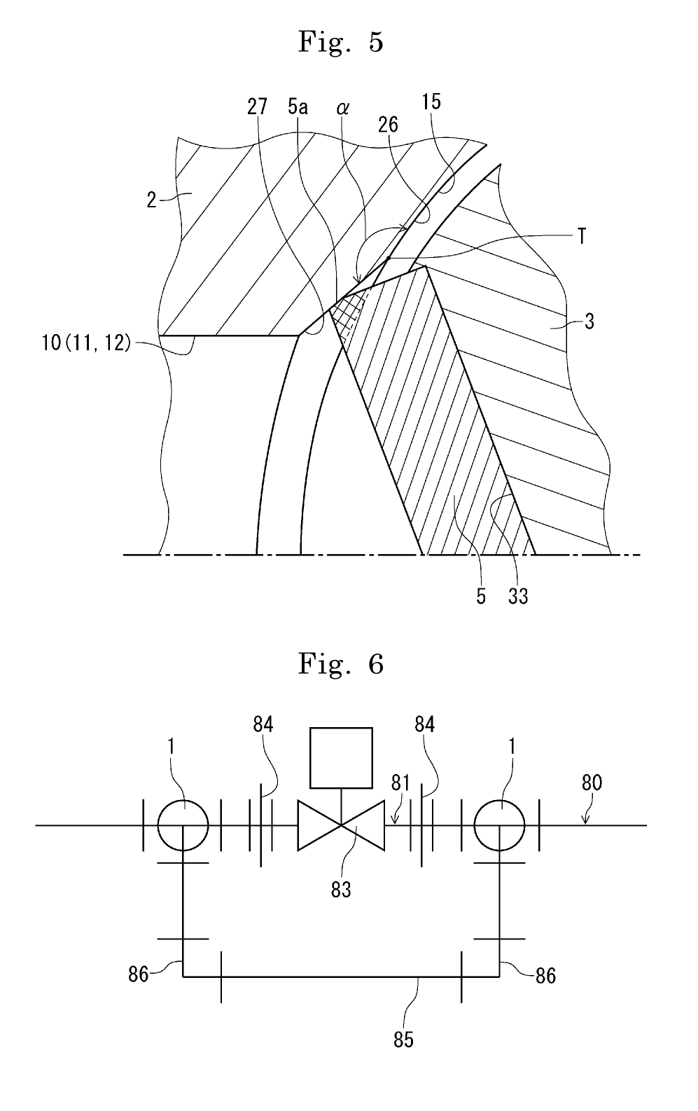

As depicted in FIG. 5, on a flow path port edge of the outflow/inflow ports 10 and 11 and the discharge port 12, that is, on an edge portion serving as a seal part 26 closely contacted and sealed by the seal member 5, a chamfered part 27 with a predetermined angle a (on the order of 150°) is formed. With this chamfered part 27, a deburring of the seal part 26 is made. Also, with part of the tilted angle of the seal part 26 becoming gentle, the seal member 5 rotating integrally with the valve body 3 to slide can be easily guided to the seal part 26. This angle a is an angle formed by the chamfered part 27 and a tangent of the spherical surface part 15 at a point of intersection T between the chamfered part 27 and the spherical surface part 15 and, for example, is desirably an obtuse angle set in a range on the order of 135° to 150°. When the angle a is below 135°, burrs by machining tend to occur on a portion of the point of intersection T. Also, when the angle a is above 150°, the diameter of the seal part 26 becomes large accordingly, and the rotary valve is increased.

When a seal surface 5a of the seal member 5 is positioned at the spherical surface part 15, the seal surface is pressed by this spherical surface part 15 to become in a state of being elastically deformed. On the other hand, when the valve body 3 is rotated and the seal surface 5a opposes any flow path of the outflow/inflow ports 10 and 11 or the discharge port 12, elastic deformation is released and the seal surface 5a protrudes to a flow path side. Here, since the seal surface 5a, which is about to protrude, is smoothly guided by the chamfered part 27, the seal member 5 does not hang on the edge portion of the seal part 26, and rotating operation can be smoothly performed. When the valve body 3 is fully closed, the seal surface 5a seals the seal part 26 by surface contact to improve sealability. A chamfered width dimension of the chamfered part 27 preferably allows the seal member 5 to easily slide and the seal member 5 to be less prone to be damaged.

The valve body 3 is inserted in the valve body accommodating part 16 from the opening 22 of the body 2, and is rotatably mounted as being vertically positioned by the lid member 4. In the valve body 3, at a position opposing the spherical surface part or the tapered surface part of the valve body accommodating part 16, a spherically-shaped surface part or a tapered-shaped surface part is formed. In the present embodiment, a spherically-shaped surface part 28 is provided at a position opposing the spherical surface part 15 as part of the valve body 3, and the outer circumferential surface of this spherically-shaped surface part 28 is formed in a hemispherical shape.

In FIG. 2 and FIG. 3, on the outer circumferential surface of the spherically-shaped surface part 28, a plurality of through ports 30, 31, and 32 capable of communicating the outflow/inflow ports 10 and 11 or the discharge port 12 are formed in three directions. In a lateral direction crossing these through ports 30, 31, and 32, a attachment groove 33 that can oppose the outflow/inflow ports 10 and 11 or the discharge port 12 is formed. To the attachment groove 33, the elastic seal member 5 capable of closing the outflow/inflow ports 10 and 11 or the discharge port 12 is attachably and detachably attached, and the valve main body 1 is provided in a single seat structure by the seal member 5. In the present embodiment, the attachment groove 33 is a circular recessed groove, and the seal member 5 is formed in a substantially disc shape capable of fitting in this circular recessed groove 33. Specifically, at least a surface of the seal member 5 opposing the spherical surface part 15 is formed to have a flat surface (to be flat). Although not depicted, the through ports and the outflow/inflow ports and discharge port may be each in four or more directions. In this case, each spacing between each through port and each outflow/inflow port and each discharge port is smaller than 90°.

The through ports 30, 31, and 32 are each formed in a full-bore shape having a diameter substantially equal to that of the outflow/inflow ports 10 and 11 or the discharge port 12, and have a pressure loss suppressed when communicating with these outflow/inflow ports 10 and 11 or discharge port 12. Other than a full bore shape, the through ports 30, 31, and 32 can be of a narrowed-diameter type called a standard bore shape with a flow path diameter being in one step (being reduced) than this full bore shape or a reduced bore type with a flow path dimeter being in two steps. In the case of a full bore type, compared with other types, the pressure loss can be suppressed, and flow characteristics is improved.

In FIG. 1 to FIG. 3, an upper stem 35 is integrally or separately provided above the valve body 3. On this upper stem 35, the handle 7 can be mounted. At that handle mounting position, a fit-in projecting part 36 is formed. On a side opposing the upper stem 35 of the valve body 3, a lower stem 37 is integrally provided. These upper stem 35 and lower stem 37 are provided so as to have a substantially same shaft diameter to provide a uniform pressure by in-piping air pressure to the valve body 3.

The valve body 3 is provided in a shape be insertable in the spherical surface part 15. In this case, if the through ports 30, 31, and 32 and the seal member 5 rotate so as to oppose the outflow/inflow ports 10 and 11 or the discharge port 12 to be able to switch a flow path, a portion corresponding to the spherically-shaped surface part 28 may have a shape other than a hemispherical surface. This spherically-shaped surface part 28 and the above-described tapered-shaped surface part can be formed at least at a position opposing the spherical surface part 15 or the tapered surface part of the valve body accommodating part 16 and in a region where the attachment groove 33 is provided. A valve body shape in another region may be another shape as long as the through ports 30, 31, and 32 can be installed. A gap G is provided between the spherically-shaped surface part 28 and the spherical surface part 15, and is provided so that the amount of additional tightening of the valve body 3 can be regulated by adjusting the amount of this gap G by rotation of the lid member 4.

The seal member 5 attached to the valve body 3 is formed of a high-polymer material such as, for example, PTFE (polytetrafluoroethylene) or PTFE containing carbon fiber. When the valve body 3 rotates, the seal member 5 rotates integrally with this valve body 3 to be able to seal any of the outflow/inflow ports 10 and 11 or the discharge port 12 each and, on the other hand, allows a fluid to flow to each flow path when shifted from the outflow/inflow ports 10 and 11 or the discharge port 12.

The lid member 4 is provided in a lid shape capable of covering the opening 22. On its upper outer periphery, a columnar part 40 is formed. To an outer periphery of the columnar part 40, an O ring 42 is attached, and is provided so as to have an outer diameter capable of fitting in the opening 22 of the body 2 in a sealed state. To a lower outer periphery of the columnar part 40, a male screw 43 that can be screwed in the female screw 23 of the body 2 is provided. With screw attachment between these male screw 43 and female screw 23, the lid member 4 can be fastened. At a center position of the lid member 4 on a valve body 3 side, an insertion hole part 45 is provided. With a portion between this insertion hole part 45 and the columnar part 40 being thinned, the entire weight is reduced. In FIG. 2, the lid member 4 is provided so as to have a suppressed height, thereby suppressing the entire height of the valve main body 1.

In the valve body 3, the upper stem 35 is inserted in the insertion hole 18 of the body 2 via a seal member 47 formed of an 0 ring, and the lower stem 37 is inserted in the insertion hole part 45 of the lid member 4 via a seal material 47′. With this, the valve main body 1 is provided in a trunnion structure, with the valve body 3 axially supported between the body 2 and the lid member 4. Between the upper stem 35 and the body 2, a gap dimension 46 is provided. This gap dimension 46 is provided so as to be larger than the gap G when the rotary valve of the present invention is assembled, and the dimension is set so as not to affect additional tightening of the valve body 3.

Although not depicted, between a lower inner circumferential surface of the valve body accommodating part 16 and a lower outer circumferential surface of the valve body 3, a retaining ring, which will be described further below, may be interposed. When a retaining ring is attached, this retaining ring is interposed between a lower bottom surface of the valve body 3 and an upper surface of the lid member 4, thereby regulating movement of the valve body 3 in a direction of the lid member 4.

Between the lower stem 37 of the valve body 3 and the insertion hole part 45 of the lid member 4, the spring member 6 is attached. With the resilient force of this spring member, the seal member 5 is pressed, any one of the outflow/inflow ports 10 and 11 or the discharge port 12 is hermetically sealed and closed, the outflow/inflow port 10, 11 and the discharge port 12 or the outflow/inflow ports 10 and 11 are provided so as to be able to communicate mutually via the through ports 30, 31, and 32. Arranged outward (non-flow-path side) of the seal member 47′, this spring member 6 does not make contact with the fluid, undue consideration of corrosion resistance is not required, material selection is easy, and the arrangement is excellent in durability.

The spring member 6 is formed of, for example, a disc spring, and is compressed by fastening of the lid member 4 to be able to push the valve body 3 in an inserting direction. By providing the spring member 6, adhesion between the seal member 5 and the spherical surface part 15 is increased, and a primary back pressure (bi-flow) sealability is also ensured. Furthermore, while a dimensional error of the body 2 and the valve body 3 is absorbed by the spring member 6, the valve body 3 is attached at a predetermined position of the valve body accommodating part 16. The spring member 6 may be of a mode other than a disc spring as long as it has a resilient force. Here, when the spherically-shaped surface part 28 of the valve body 3 is inserted so as to oppose the spherical surface part 15 of the valve body accommodating part 16 described above, a wedge effect is exerted on the seal member 5, thereby increasing seal surface pressure by the seal member 5. Thus, the resilient force of the spring member 6 can be suppressed low, and the size of this spring member 6 can be decreased.

While the pressing force of the seal member 5 is adjusted via this spring member 6, the opening 22 is covered with the lid member 4, and the valve body 3 is provided so as to be able to be additionally tightened by the lid member 4.

In FIG. 1 to FIG. 3, for example, an exhaust-purpose orifice 8 may be attached to the discharge port 12. The orifice 8 is provided so as to have an outer diameter that can be accommodated in the counter-bored part 24 depicted in FIG. 4, and has a communication hole 60 having a predetermined hole diameter drilled at its center part. The orifice 8 is covered with an annular cover 61, and this cover 61 is screwed and fixed in the body 2 with a screw 62. With this structure, the discharge port 12 is provided so as to be narrowed down to have a predetermined diameter when the orifice 8 is mounted and, on the other hand, pressure air can be exhausted from the bore of the discharge port 12 when the orifice 8 is removed. Although not depicted, female screws of the body 2 for fixing the cover 61 are formed at, for example, four locations of the body at spacing of 90°.

To the discharge port 12, a dust-proof cap not depicted may be attachably and detachably provided, with its orientation freely set by using the female screws. In this case, immersion of a foreign matter from the discharge port is prevented by the dust-proof cap.

While the orifice 8 is provided in a structure attachable to and detachable from the discharge port 12 in the present embodiment, a screw attachment part may be provided on a discharge port 12 side, similarly to the outflow/inflow ports 10 and 11. In this case, to the discharge port 12 and the outflow/inflow ports 10 and 11, another component can be connected by screw attachment, such as an elbow pipe not depicted, or a muffler for reducing discharge sound, a check valve such as a lift check valve for non-return, or the like. Also, although not depicted, a nozzle capable of changing the direction of pressure air may be mounted on a discharge side of the discharge port 12 by a screw or the like.

With operation of the handle 7 depicted in FIG. 1, the valve body 3 is provided so as to be able to be opened and closed. In this handle 7, a substantially-cross-shaped fit-in hole not depicted is provided. This fit-in hole is provided so as to allow the fit-in projecting part 36 to fit in. The handle is provided so as to be able to be attached via the fit-in hole to the upper stem 35 at a spacing of 90° in any orientation. In this case, if the handle 7 can be attached to the upper stem 35 at a spacing of 90°, the fit-in hole and the fit-in projecting part 36 may have a fitting shape other than a substantially cross shape. In the handle 7, a notched-shaped stopper part 52 is formed. With this stopper part 52 abutting on and engaging with the engagement pin 21 put in any one of the four mounting holes 20, the orientation and the operating direction of the handle 7 can be set, and also this handle 7 can be switched by rotating operation at 90° in any operating direction to switch the flow path.

In FIG. 1 to FIG. 3, when the valve main body 1 is assembled, firstly, the orifice 8 is set to be in a state of being accommodated on a discharge port side, and the cover 61 is fixed with the screw 62 from above to fix the orifice 8 to the body 2. On one hand, the seal member 5 and the seal materials 47 and 47′ are attached to the valve body 3, this valve body 3 is inserted from the opening 22 into the valve body accommodating part 16 of the spherical surface part 15 from a lower part of the body 2, and the upper stem 35 is inserted in the insertion hole 18. Here, the seal member 5 is in contact with the body 2 in a state in which a pressing force does not act.

Next, the spring member 6 with a washer not depicted is attached to the lower stem 37. While the lower stem 37 is inserted in the insertion hole 45 of the lid member 4, the lid member 4 is integrated from the lower part of the body 2 by screw attachment between the male screw 43 and the female screw 23, and the valve body 3 is pressed by the lid member 4 via a thrust washer 9′. Here, the lid member 4 is fastened/disassembled by a general-purpose tool such as a socket wrench not depicted, and the seal member 5 and the body seal surface are brought into close contact with each other by adjusting the fastening amount of the lid member 4 to form the seal surface 5a on the seal member 5. After the pressing force of the seal member 5 by the spring member 6 is set to be in an appropriate state, the lid member 4 is attached to the body 2. Furthermore, by adjusting the fastening amount of the lid member 4 in a state in which the valve main body 1 is installed, seal leakage due to abrasion, degradation, or the like of the seal member 5 becomes repairable.

In this embodiment, the structure is a so-called bottom entry structure, where the valve body 3 is inserted from below the body 2. Thus, while the position of the valve body 3 with respect to the body 2 is adjusted by the lid member 4 and a dimensional error of the body 2 and the valve body 3 is absorbed, the valve body 3 can be easily attached at a predetermined position of the valve body accommodating part 16. The valve main body 1 may be provided so as to have a top entry structure, where the valve body 3 is inserted from above the body 2.

Subsequently, the engagement pin 21 is put in any one of the mounting holes 20, the fit-in projecting part 36 of the upper stem 35 is fitted in the fit-in hole for fixing with a fixing nut 56 via a washer member 55. With this, while any orientation and open/close operating direction are set, the handle 7 is attached to the upper stem 35.

In this case, the orientation of the discharge port 12 can be reversed by 180° by switching the orientations of the two outflow/inflow ports 10 and 11 in series, the orientation of the handle 7 in an open state can be changed via the fit-in hole and the fit-in projecting part 36 to a direction parallel to or crossing the outflow/inflow ports 10 and 11, and the operating direction of the handle 7 at the time of opening/closing can be changed by putting the engagement pin 21 in any mounting hole 20 of the body 2. By combining these three elements, valves of various modes can be configured. That is, the conduit of the discharge port 12 for exhausting air at a closed position can be on one of two sides, that is, a right side or a left side, with respect to the outflow/inflow ports 10 and 11 in series; the open position of the handle 7 can be of one of two types, that is, a parallel open type or a right-angled open type; and the operating direction of the handle 7 can be any of two types, that is, a so-called right-hand type or left-hand type. Thus, by combining these, rotary valves of 2×2×2=8 types can be provided.

After assembling of the valve main body 1, the handle 7 is operated to rotate while the gap G is provided between the valve body accommodating part 16 and the spherically-shaped surface part 28, and the valve body 3 is rotated by each 90° while an accident due to misoperation is prevented, thereby causing any one set or all of the outflow/inflow ports 10, 11, and 12 to communicate via the through ports 30, 31, and 32 and the seal member 5 to allow the flow path to be switched. At a closed position of the valve body 3, the seal member 5 is in a state of hermetically sealing any of the outflow/inflow ports 10, 11, and 12.

In FIG. 4(a), a state is depicted in which the left and right outflow/inflow ports 10 and 11 are caused to communicate to allow pressure air to be supplied and the discharge port 12 is directly sealed with the seal member 5. In FIG. 4(b), a state is depicted in which the outflow/inflow port 10 on a primary side is sealed with the seal member 5 to cause the outflow/inflow port 11 on a secondary side and the discharge port 12 to communicate. In this case, pressure air is discharged from the outflow/inflow port 11 through the discharge port 12. In FIG. 4(c), a state is depicted in which the outflow/inflow port 11 on the primary side is sealed with the seal member 5 to cause the outflow/inflow port 10 on the secondary side and the discharge port 12 to communicate, and pressure air is discharged from the outflow/inflow port 10 through the discharge port 12.

Other than these, there is a state in which all of the two outflow/inflow ports 10 and 11 and the discharge port 12 are provided so as to be able to communicate. However, this is not suitable when the rotary valve is used as, for example, an exhaust valve for a railway vehicle, and therefore its description is omitted.

Note that, although not depicted, three or more outflow/inflow ports may be provided to the body of the valve body, one discharge port is provided among these outflow/inflow ports, and at least any one of the outflow/inflow ports and the discharge port may be caused to communicate.

Also, without attachment of an orifice, a communication hole having a desired discharge port area at the discharge port of the body may be formed directly by boring machining.

Next, the operation of the rotary valve in the present invention in the embodiment is described.

In the valve main body 1 in the embodiment of the present invention described above, the inflow ports 10 and 11 and the discharge port 12 are formed in the valve body accommodating part 16 having the spherical surface part 15 so as to have a substantially same diameter, the valve body 3 including the spherically-shaped surface part 28 having the through ports 30, 31, and 32 and the seal member 5 is rotatably inserted from the opening 22, a communication state between the outflow/inflow ports 10 and 11 and the discharge port 12 and the through ports 30, 31, and 32 with a full bore diameter is ensured, any one of the outflow/inflow ports 10 and 11 or the discharge port 12 is hermetically sealed and closed by the seal member 5, and the outflow/inflow ports 10 and 11 and the discharge port 12 or the outflow/inflow ports 10 and 11 are provided so as to be able to communicate mutually via the through ports 30, 31, and 32. With this, operability is enhanced by low torque characteristics while a pressure loss is suppressed, and abrasion of the seal member 5 is suppressed while a sealing force is enhanced. Thus, sealability can be improved.

In this case, the valve main body 1 is provided in a trunnion structure, with the upper stem 35 axially inserted in the insertion hole 18 of the body 2 and the lower stem 37 axially inserted in the insertion hole part 45 of the lid member 4. Thus, the valve body 3 does not move by pressure to the secondary side. With the seal member 5 closing the outflow/inflow ports 10 and 11 or the discharge port 12 disposed on a valve body 3 side, unlike general ball valves, the flow path can be switched by using one seal member 5 without requiring a plurality of ball seats. Thus, the spherical surface part 15 of the body 2, the spherically-shaped surface part 28 of the valve body 3, and the seal member 5 do not require high processing accuracy, the number of components is reduced, and the entirety is simplified, thereby allowing size and weight reduction.

By ensuring processing accuracy of the spherical surface part 15 of the valve body accommodating part 16, more specifically, the seal part 26 of the outflow/inflow ports 10 and 11, simple assembling into a predetermined state can be made, while sealability is ensured when the valve body 3 is inserted into the body 2 and is covered with the lid member 4. At the time of assembling, the seal member 5 is put at a desired position, thereby allowing various types of flow path switching. Also, since it is enough for the seal member 5 to be arranged at only one location, unlike a floating ball with ball seats disposed on primary and secondary sides, a hermetically-sealed space is not formed, and an occurrence of abnormal pressure rising is avoided.

At the time of valve closing, the seal member 5 is pressed by the seal part 26 of the outflow/inflow ports 10 and 11 or the discharge port 12 to cause the seal surface 5a to be elastically or plastically deformed, and high sealability is exerted to reliably prevent mixing of a foreign matter and fluid leakage. For example, even if the seal member 5 is about to expand by supply of high-temperature air, a seal sealing force is added due to a pressurized structure by the spring member 6, and leakage occurring due to trapping, creeping, relaxation, or the like is prevented. Even if the seal member 5 is about to be shrunk at the time of low temperatures, a necessary fluid sealing and pressing force can be obtained from the spring member 6 to ensure sealability, and stable seal performance resistant also to vibration is exerted.

From the above, high sealability is exerted also for highly-pressurized pressure air while compactability is maintained.

At the time of assembling, the valve body 3 having the seal member 5 attached in advance is inserted from the opening 22 of the body 2 provided in a one-piece structure, and the lid member 4 is screwed while the spring member 6 is attached. Only by doing so, simple assembling can be made. With the one-piece structure, outside leakage from the body 2 after piping can be prevented. At the time of replacement of the seal member 5, consumables, and so forth, it is not required to remove the body 2 from the piping, and therefore the number of processes in assembling operation or at the time of replacing consumables and so forth can be minimized. With the bottom entry structure, the structure is such that the valve body 3 is pressed by the spring member 6 into the body 2, and therefore there is no danger that the valve body 3 may burst out to the outside, and safety is ensured.

From these, for example, even if the valve main body 1 is used for piping of a railway vehicle, its connection and maintenance are facilitated. Also for vibrations, leakage and so forth are prevented, and these operations can be performed safely.

Furthermore, at the time of assembling, the lid member 4 is screwed in the opening 22, the gap G is provided between the spherical surface part 15 and the spherically-shaped surface part 28 when the male screw 43 is screwed in the female screw 23, the spherically-shaped surface part 28 of the valve body 3 and the spherical surface part 15 can rotate without sliding, and fluid pressure is added to the seal member 5 only at the time of closing. Thus, without using a lubricating agent such as grease, abrasion of the seal member 5 is minimized. Furthermore, deformation and movement by fluid pressure are also prevented, and high sealability and durability of the seal member 5 can be kept. With abrasion of the seal member 5 suppressed, economic efficiency is also excellent.

With the opening 22 covered with the lid member 4 so as to be able to be additionally fastened and with any one of the outflow/inflow ports 10, 11, and 12 hermetically sealed and closed by the seal member 5 with a resilient force of the spring member 6 attached to this lid member 4, the spring member 6 follows so as to expand as appropriate in accordance with abrasion of the seal member 5. This allows sealability to be ensured. Furthermore, if the seal member 5 is abraded due to degradation with time and repeated opening/closing operation of the valve body 3 and it becomes difficult to keep sealability, the lid member 4 is additionally tightened to make the pressing force of the seal member 5 strong, thereby allowing sealability to be returned. Thus, it is not required to frequently replace the seal member 5. To the seal member 5, application of biased pressure from the fluid pressure is difficult, and its deformation is prevented to enhance durability.

In the two outflow/inflow ports 10 and 11, with a supply port of pressure air being switched, even if the handle operation for exhausting air from the discharge port 12 is varied, the handle 7 is provided so as to be able to be attached to any orientation at a spacing of 90° via a fit-in hole 51, and the engagement pin 21 allowing the stopper part 52 to be engaged in any one or two of the mounting holes 20 provided at a spacing of 90° is put in the body 2, thereby allowing the handle 7 to be attached in any open/close operating direction. By using the body 2 and the handle 7 of one type, mounting at different piping places and orientations can be made, and installation is possible even in a narrow installation space while operability is ensured.

In this case, at the time of rotating operation of the handle 7, with the stopper part 52 engaging with the engagement pin 21 at a spacing of 90°, operation can be reliably performed to a predetermined angle while erroneous operation is prevented. Even if the valve main body 1 is installed in a narrow place, dark place, or the like by rotating the handle 7 to a regulatory position, the valve body 3 can be easily operated to a desired open/close state.

The above-described valve main body 1 is provided, for example, to part of a conduit where pressure air flows, but is not restricted to be applied to pressure air and can be applied to water and other various fluids.

For example, the valve main body 1 is provided as part of a conduit 80 depicted in FIG. 6. In this case, the outflow/inflow ports 10 and 11 and the discharge port 12 are connected to the conduit 80, and the flow path of the conduit 80 is provided so as to be able to be switched by the valve main body 1 or discharge a fluid from the discharge port 12.

In the conduit 80, on a main flow path 81, two valve main bodies 1 and 1 and a control valve 83 are arranged, and union joints 84 and 84 are arranged on primary and secondary sides of this control valve 83. The conduit 80 is provided with a bypass flow path 85. This bypass flow path 85 is branched at the valve main body 1 on the primary side of the main flow path 81, and is merged via two elbow pipes 86 and 86 to the valve main body 1 on the secondary side of the main flow path 81.

With this structure, unnecessary tee pipes and valves can be reduced to decrease the number of components and make the bypass flow path 85 compact. The material cost of piping components can be reduced, the weight of piping can be reduced and, furthermore, valve operation can be simplified. Still further, by mounting a purge valve not depicted on the valve main body 1, a purge can be carried out for each block configuring the bypass flow path 85, and pressure inspection inside the conduit 80, fluid sampling, a fluid purge, pressure relief, and so forth can be performed.

In the conduit 80, to let a fluid flow through the main flow path 81, the valve main bodies 1 and 1 on the primary and secondary sides is operated to rotate to cause a fluid passage port to a direction of the bypass flow path 85 to be in a sealed state, and the fluid is let flow through the main flow path 81 while flow and pressure control is performed by the control valve 83.

On the other hand, to let a fluid flow through the bypass flow path 85, the valve main body 1 on the primary side is operated to rotate to a port position where a fluid passage port in the direction of the main flow path 81 is sealed, and the valve main body 1 on the secondary side is operated to rotate to seal a fluid passage port of the main flow path 81 on an upstream side. This causes the fluid to flow through the bypass flow path 85 at the time of, for example, maintenance.

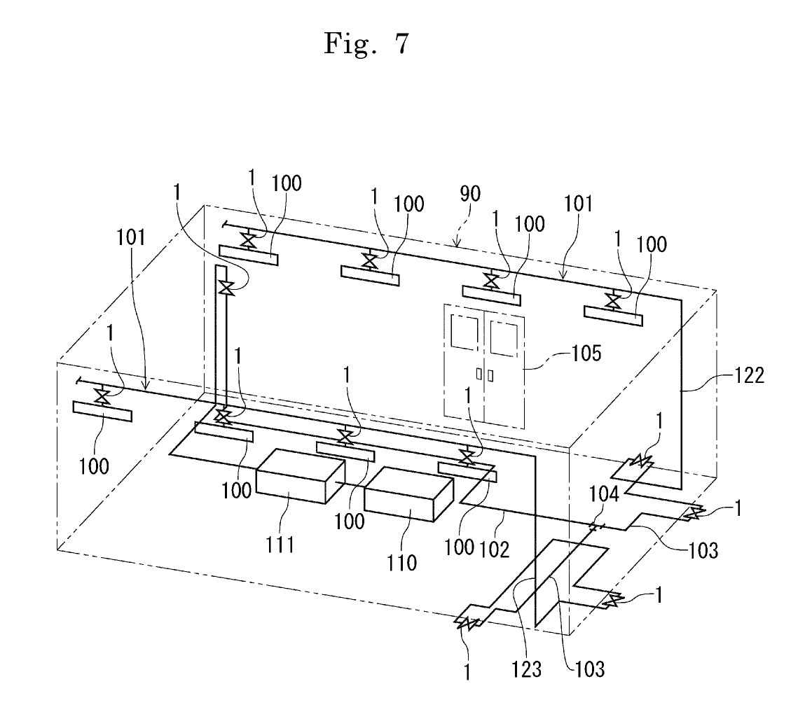

As depicted in FIG. 7, the above-described valve main body 1 can be used as a quick exhaust valve for a railway vehicle 90. In this case, by connecting the exhaust valve to a conduit of the railway vehicle and adjusting a discharge port area S depicted in FIG. 2 as appropriate, an exhaust time for exhausting air from an automatic door opening/closing apparatus piping in case of emergency, security, or the like can be set constant.

The valve main body 1 is disposed in the course of a conduit of a main pipe 102 and branch pipes 103 of an air piping 101 for driving an automatic door opening/closing apparatus 100 of a railway vehicle 90 indicated by two-dot-chain lines, or a plurality of the valve main bodies 1 can be disposed at a conduit branching part 104. On each valve main body 1, an orifice with a predetermined diameter is mounted. The discharge port area S of this orifice is set as appropriate for adjustment so as to make the exhaust time constant.

With this, in accordance with the disposing position of the valve main body 1 in the railway vehicle 90, a size and weight reduction of the entire air piping 101 is achieved, and air can be exhausted for a constant short period of time even if the piping capacity is varied with changes of a pattern at the time of door opening and closing. Here, the valve main body 1 can be operated with light force, and can be connected to the air piping 101 via the body 2 in an integrated structure. Therefore, external leakage of pressure air can also be prevented.

Furthermore, if the valve main body 1 is provided in the course of the air piping 101 for door opening in the vehicle's interior or exterior of the railway vehicle 90, an automatic door 105 can be set in an open state by manual operation from the inside and outside of the railway vehicle 90. Therefore, air in a desired area of the air piping 101 can be quickly exhausted in case of emergency or security.

The piping of the railway vehicle 90 is provided with a compressing apparatus 110 formed of a compressor and an air reservoir part 111 formed of a chamber and accumulator on a primary side. To these components, the air piping 101 as a pressure air supply/exhaust path for driving the automatic door opening/closing apparatus 100 is connected. To the air piping 101, the automatic door opening/closing apparatus 100 having a cylinder inside, which is driven by opening and closing of a solenoid valve not depicted, and the valve main body 1 are disposed. In this railway vehicle 90, pressure air generated by the compressing apparatus 110 is supplied via the air reservoir part 111 to the air piping 101.

The air piping 101 indicated by solid lines is branched by a T-shaped joint as a conduit branching part 104 in mid course into a first branch path 122 and a second branch path 123 on left and right, both as the branch pipes 103. These first and second branch paths 122 and 123 are each provided with the plurality of automatic door opening/closing apparatuses 100. In the course of the conduit of the main pipe 102 and the branch pipes 103 of the air piping 101, the two-way-type valve main bodies 1 described above are disposed. Also, in place of the T-shaped joint 104, the valve main body 1 may be provided to the conduit branching part. Among these, the valve main body 1 provided on the primary side from the T-shaped joint 104 is provided so as to communicate the outflow/inflow ports 10 and 11 and the discharge port 12 of the piping path via the through ports 30, 31, and 32 to allow pressure air to all of the automatic door opening/closing apparatuses 100 to be discharged or so as to mutually communicate the outflow/inflow ports 10 and 11 via the through ports 30, 31, and 32 to allow pressure air to be supplied to all of the automatic door opening/closing apparatuses 100.

In the first branch path 122 and the second branch path 123, the valve main body 1 provided between the T-shaped joint (conduit branching part) 104 and the automatic door opening/closing apparatus 100 is provided so as to communicate the outflow/inflow ports 10 and 11 and the discharge port 12 of the piping path on a T-shaped joint 104 side to allow pressure air to all of the automatic door opening/closing apparatuses 100 on each of the left and right sides to be discharged or so as to mutually communicate the outflow/inflow ports 10 and 11 to allow pressure air to be supplied to all of the automatic door opening/closing apparatuses 100 on each of the left and right sides.

The valve main body 1 provided to a primary side of each automatic door opening/closing apparatus 100 is provided so as to communicate the outflow/inflow ports 10 and 11 and the discharge port 12 to this automatic door opening/closing apparatus 100 to allow pressure air to the automatic door opening/closing apparatus 100 to be discharged or so as to mutually communicate the outflow/inflow ports 10 and 11 to allow pressure air to be supplied to the automatic door opening/closing apparatus 100.

In this embodiment, the valve main body 1 provided to each of the inside and outside of the railway vehicle 90, and each valve main body 1 is operated to open and close, thereby allowing pressure air to the automatic door opening/closing apparatus 100 to be discharged or supplied from the inside and outside of the railway vehicle 90. In more detail, the valve main body 1 on the primary side from the first branch path 122 and the second branch path 123 is provided, although not depicted, in a state of being hidden at normal times by a glass plate provided at an appropriate position inside the railway vehicle 90 so as to be able to be opened and closed with a hinge and, in case of emergency, security, or the like, can be manually operated with the handle 7 from the inside of the railway vehicle 90 by opening this glass plate. The valve main bodies 1 provided in a state of being exposed on left and right sides and forward and backward sides outside the railway vehicle 90 are provided so as to be manually operated from the respective directions outside the railway vehicle 90. The valve main body 1 provided above each automatic door 105 is provided in a state of being hidden by a steel plate provided so as to be able to be opened and closed with a hinge, and is provided so as to be manually operated from the inside of the railway vehicle 90 by opening the steel plate.

In FIG. 7, at normal operation, the outflow/inflow ports 10 and 11 of all of the valve main bodies 1 are communicated mutually, and become in a state capable of supplying pressure air to the automatic door opening/closing apparatus 100. In this case, a cylinder is driven by opening and closing the solenoid valve to automatically operate the automatic door opening/closing apparatus 100 for opening and closing, thereby allowing boarding to and discharging from the railway vehicle 90 and so forth.

To the discharge port 12 of each valve main body 1 in the railway vehicle 90, the orifice 8 with each different discharge port area S is attached. While the exhaust time can be set constant even in any exhaust state, this exhaust time can be provided so as to be able to be reduced. With this, without an influence from a different capacity (length) of the door opening/closing air piping 101 depending on the railway vehicle 90 and the disposing position of the valve main body 1, the hole diameter of the orifice 8 is set from outside to adjust a time until manual door opening operation. In the present embodiment, for example, a discharge port of φ10 mm can be achieved with a body in a one-piece structure, and the pressure inside the air piping 101 can be discharged, for example, within five seconds, to allow opening operation of the door.

Furthermore, the valve main body 1 can be disposed in the course of the conduit of the main pipe 102 and the branch pipes 103 of the air piping 101 or to the conduit branching part 104. Thus, the air piping 101 different for each railway vehicle 90 can be arranged at a desired position. The flow path is switched for quick exhaustion from a desired position to allow air in a certain region inside the railway vehicle 90 to be exhausted within a predetermined time. Furthermore, even if piping is complex, the valve main body 1 is provided at a predetermined position in that piping to allow the exhaust time of pressure air to be reduced within a predetermined time. With the valve body 3 attached inside the valve main body 1 via the spring member 6, vibrations of the railway vehicle 90 can be absorbed by the spring member 6, and sealability can be kept.

Next, a second embodiment of the rotary valve of the present invention is described. Note that a portion identical to that of the above-described embodiment is represented by a same reference sign, and its description is omitted.

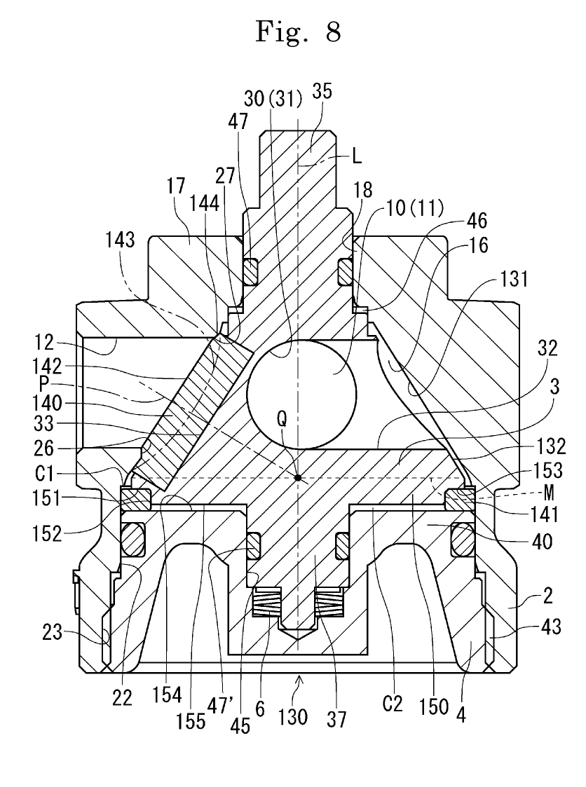

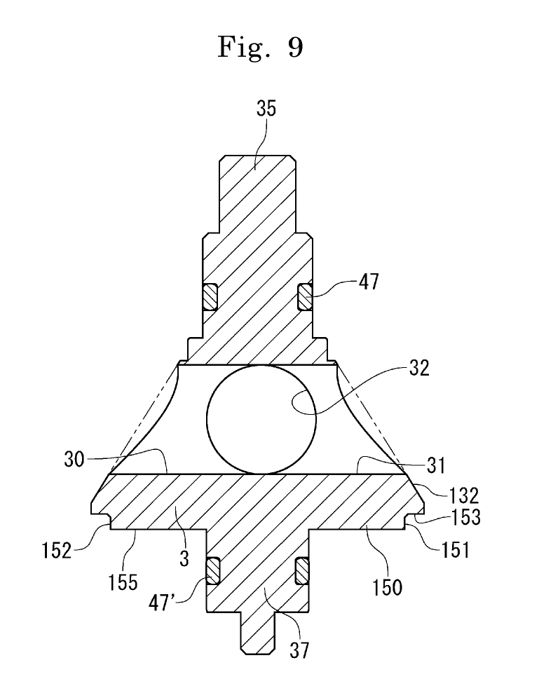

In FIG. 8, another embodiment of the rotary valve of the present invention is depicted. In a valve main body 130 in this embodiment, a tapered surface part 131 is formed on part of an inner periphery inside the body 2 and a tapered-shaped surface part 132 is formed at a position opposing the tapered surface part 131 on an outer periphery of the valve body 3 of FIG. 9. To the attachment groove 33 of the valve body 3, a seal member 140 is attached. Furthermore, a retaining ring 141 is attached inside the valve main body 130.

Here, when part of the inner periphery inside the body 2 is the spherical surface part 15 as in the above-described first embodiment, with this spherical surface part 15 being a recessed-shaped spherical surface, even if a portion opposing the flow path of the outflow-inflow ports 10 and 11 or the discharge port 12 is provided in a flat shape like the above-described seal member 5, this seal member 5 can be prevented from protruding to a flow path side of the seal part 26.

On the other hand, if the tapered surface part 131 is provided to part of the inner periphery inside the body 2 of FIG. 8, when a seal member is provided to this tapered surface part 131 so as to have the same shape as that of the above-described spherical surface part 15, the seal member becomes in a state of being pushed to the inside of the flow path more than the seal part 26 in a valve closed state. When the valve body 3 is rotated from this state, the seal member forcibly makes contact with a port edge of the flow path to be possibly damaged.

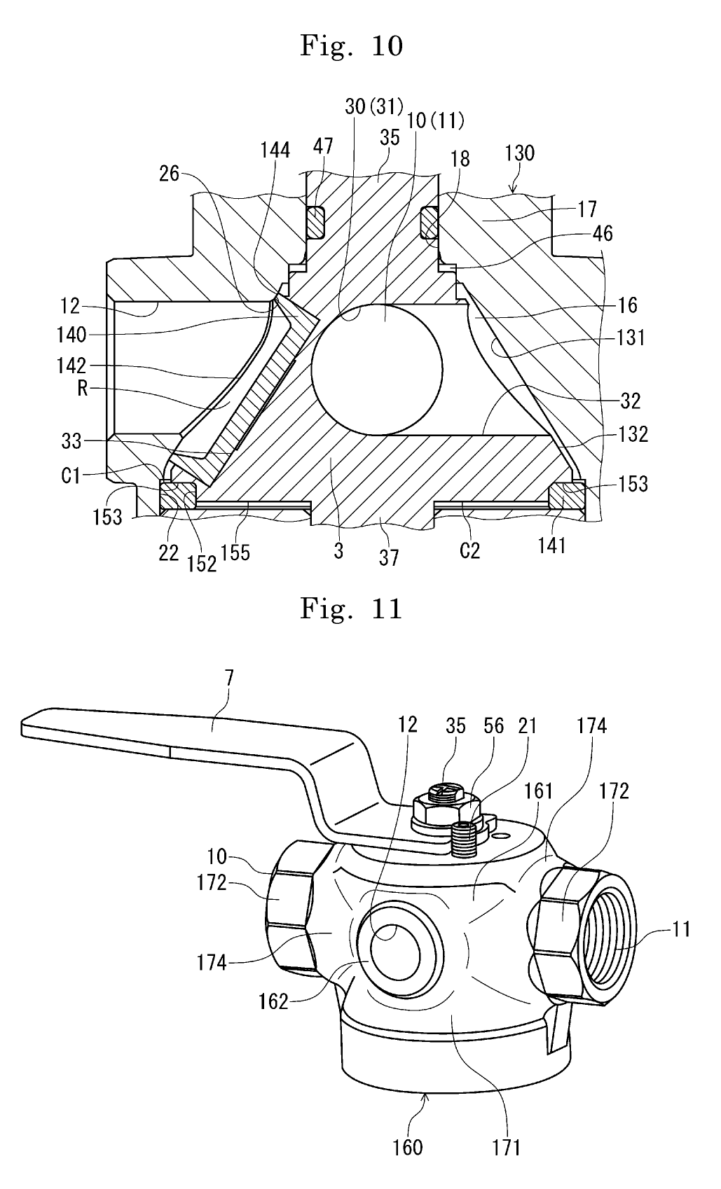

To avoid this, in the valve main body 130, as depicted in FIG. 10, a region R to be pushed to a flow path side in a seal member 140 is desirably deleted in advance. In this case, it is possible to prevent this seal member 140 from forcibly making contact with the seal part 26 to prevent damage and wear. Also, smooth valve opening operation can be performed. Specifically, when part of the inner periphery of the body 2 is formed as the tapered surface part 131 and part of the valve body 3 is formed as the tapered-shaped surface part 132, any shape can be taken unless a surface opposing the flow path of the seal member 140 at the time of valve full closing, that is, a non-seal surface 142, slidably makes contact with the tapered surface part 131. On this non-seal surface 142, the region R or a recess 143 in a recessed spherical surface shape depicted in FIG. 8 can be formed. This prevents damage and abrasion due to a slidable contact of the non-seal surface 142.

Furthermore, a clearance part, not depicted, formed of a countersink may be provided to the non-seal surface 142 of the seal member 140. A seal surface 144 of this seal member 140 may possibly be elastically deformed so as to project to a flow path side because of being pressed by the seal part 26 by surface abutting. If a clearance part is provided, an elastically deformed portion is deformed to this clearance part side, thereby preventing projection to the flow path side.

When the recess 143 and the clearance part are provided to the non-seal surface 142 of the seal member 140, it is desirable to provide these each with an appropriate shape and size and to form the seal surface 144 in an R shape or the like capable of improving sliding friction or sealability with the seal part 26 at the time of rotation of the valve body 3.

In this valve main body 130, when an axial center of rotation is taken as L and a lower end of the tapered-shaped surface part 132 or the above-described spherically-shaped surface part, that is, a boundary with a columnar-shaped projectingly-provided part 150, is taken as M, the seal member 140 is installed so that its center line P passes through a point of intersection Q of L and M. Thus, while the rotary valve is in a compact structure, the valve body 3 can be smoothly rotated.

The retaining ring 141 of FIG. 8 is annularly formed of a material having a strength larger than that of the seal member 140 and a coefficient of linear expansion smaller than that of the seal member 140, and is provided by using a resin material such as, for example, POM (polyoxymethylene). POM has an approximately 90% of the coefficient of linear expansion of PTFE. When the retaining ring 141 is provided by using this material, a decrease in seal surface pressure of the seal member 140 can be prevented.

If the retaining ring 141 having a coefficient of linear expansion equivalent to that of the seal member 140 is used, changes in dimension of the seal member 140 and the retaining ring 141 due to temperature changes have the same tendency, and the sealing performance of the seal member 140 may possibly be impaired. In particular, if a reduction in dimensions at the time of low temperatures is affected, a decrease in sealing performance and a decrease in sealing surface pressure may possibly occur.

The retaining ring 141 may be provided by using a metal material such as, for example, phosphor bronze, may be configured of a split body, or may be a partial component other than a ring shape. When the retaining ring 141 is provided by using a metal material, safety is preferably checked in consideration of an occurrence of abrasion powder and adverse effects of a metal piece on piping equipment.

When the retaining ring 141 is provided, the columnar-shaped projectingly-provided part 150 is formed from the tapered-shaped surface part 132 in the valve body 3. At a boundary position between this projectingly-provided part 150 and the tapered-shaped surface part 132, an attachment step part 151 is provided. The retaining ring 141 is interposed between the circular opening 22, which is a lower inner circumferential surface of the valve body accommodating part 16 and a lower outer circumferential surface 152 formed of the attachment step part 151 of the valve body 3, and is attached to a gap where a bottom surface edge part 153 on a bottom surface side of the valve body 3 formed of the attachment step part 151 and an upper surface 154 of the lid member 4 oppose each other.

After the retaining ring 141 is attached, in a boundary portion between the tapered surface part 131 and the opening 22, a clearance C1 is provided between the body 2 and the retaining ring 141, and a clearance C2 is provided between a valve body bottom surface part 155 and the upper surface 154 of the lid member. With this, the retaining ring 141 can move in the clearance C1 in an axial direction, and can press the valve body 3 to a fastening direction in the range of the clearance C1. With the clearance C2 being provided, a sliding contact between the bottom surface side of the valve body 3 and the upper surface side of the lid member 4 is prevented, and abrasion by friction and an increase in torque of these are avoided.

As depicted in FIG. 8, with the lid member 4 screwed and fixed at a predetermined position of the body 2 and the retaining ring 141 attached in a state of abutting on both of the valve body 3 and the lid member 4, movement of the valve body 3 to a direction of the lid member 4 is regulated.

In this manner, with the retaining ring 141 interposed between the opening 22 on the lower inner circumferential surface of the valve body accommodating part 16 and the lower outer circumferential surface 152 of the valve body 3, while center adjustment is made between the axial center of the insertion hole 18 and the axial center of the rotation axis of the valve body 3 by the outer circumferential side of this retaining ring 141 and the opening 22 and by the inner circumferential side thereof and the lower outer circumferential surface 152 of the attachment step part 151 of the valve body 3, a constant compression margin of the seal member 140 can be ensured, and eccentric action due to compression counterforce of the seal member 5 is absorbed to eliminate an imbalance in seal surface pressure, thereby making it possible to improve opening/closing operation performance.

This is described in detail. To enhance sealability by the seal member 140, the retaining ring 141 is required to uniformly ensure preloading at the time of assembling. That is, when preloading is applied to the seal member 140 of a single seat attached to the valve body 3 for compression, a cantilever compression counterforce is added to the axial center of operation of the valve body 3, and therefore a phenomenon occurs in which the valve body 3 is tilted, with an upper stem 35 side being taken as a fulcrum. If assembling is completed without correcting this tilt, a contact between the valve body shaft and a bearing side on a body side is nonuniform at the time of opening/closing operation, abnormal abrasion occurs due to fluid pressure, and a phenomenon adversely affecting smooth operation occurs, such as an increase in torque, abrasion, or galling phenomenon. If the contact of the seal member 5 is not uniform, sealing leakage tends to occur.

To avoid these, it is required to uniformly give preloading to the seal member 5 to correct an eccentric tilt due to cantilever and ensure center adjustment of the valve body axis in a radial direction. To satisfy this, it is required to enhance a bearing function between the inner circumferential side of the retaining ring 141 and the lower outer circumferential surface 152 of the valve body 3 and between the outer circumferential side of the retaining ring and the opening 22.

In an assembled state, to cause compression loading of the spring member 6 to be appropriately applied to the seal surface 144 of the seal member 140, the following structure is required for the retaining ring 141. That is, the upper surface side of the retaining ring 141 and the bottom surface edge part 153 and the lower surface side thereof and the upper surface 154 of the lid member are made contact with each other to prevent an occurrence of a gap dimension in an axial direction and ensure the compression dimension of the seal member 140 at the time of assembling the spring member 6 in an appropriate state, thereby allowing loading of assembling by the spring member 6 to be stably ensured.

By configuring the retaining ring 141 as described above, changes in magnitude of stiffness depending on the type of the material of the seal member 140 can be absorbed, and loading of sealing to be acted on the seal surface 144 after molding can be set at a desired magnitude. Also, changes in dimension due to abrasion of the seal member 140 can be measured also from outside of the valve main body 130. The amount of abrasion of the seal member 140 can be compensated for by screwing by rotation of the lid member 4, and constant loading of sealing after compensation can also be easily ensured.

Since the valve main body 130 has a structure in which the seal member 140 attached only to the primary side of the valve body 3 is pressed and sealed to the seal part 26 of the body 2, a phenomenon occurs in the valve body 3 in which the upper stem 35 is tilted to the secondary side due to counterforce of a seal surface pressure of the valve seat, with a portion axially supported by the body 2 being taken as a fulcrum. As described above, by attaching the retaining ring 141 at least between the outer periphery of the valve body 3 and the inner periphery of the body 2, this retaining ring 141 functions as a so-called radial bearing, and this tilt can be corrected.

Here, the loading in the radial direction transmitted from the valve body 3 to the body 2 is decreased as a distance from the valve axis is longer. Thus, the retaining ring 141 is desirably attached at a maximum outer circumferential position of the valve body 3.

Furthermore, the structure is adopted in which a predetermined valve seat seal surface pressure is kept by always pressing the valve body 3 by the spring member 6 attached to the lid member 4 as described above. Here, with the amount of pressing of the spring member 6 regulated by the retaining ring 141 attached between the lid member 4 and the valve body 3, the spring member 6 is prevented from being excessively pressed when the valve main body 130 is assembled or when the lid member 4 is additionally tightened, which will be described further below, and the resilient force of this spring member 6 is kept.

The retaining ring 141 is attached at least between the lid member 4 and the valve body 3, and is desirably attached to the maximum outer circumferential position of the valve body 3 so as to be used together with a function of preventing eccentricity of the valve body 3 described above.

In this manner, in the rotary valve of the present embodiment, the eccentricity preventing function of the valve body 3 and the function of recovering initially-set loading of the spring member 6 to keep the seal surface pressure by the seal member 140 can be achieved by one retaining ring 141. Therefore, the number of components can be reduced. Since the projectingly-provided part 150 is provided at the maximum outer circumferential position of the valve body 3 and in the opening 22 opposing the lid member 4 and the attachment step part 151 having an L-shaped cross section is provided by this projectingly-provided part 150, the retaining ring 141 can be attached to the attachment step part 151 while the height of the valve body is kept low, and the valve main body 130 can be made compact.

With the retaining ring 141 attached between the lid member 4 and the valve body 3, this retaining ring 141 functions also as a bearing which receives so-called thrust loading. With this bearing function, low friction and low torque characteristics are exerted at the time of valve body operation, the compression margin of the spring member 6 is set at a set value, and a decrease in sealability of the seal member 140 because of an occurrence of a weakening and a loss of the spring function of the spring member 6 due to excessive compression is prevented.

The retaining ring 141 can be attached also to the above-described valve main body 1 of the first embodiment similarly to the second embodiment. Also in this case, functions similar to those described above can be exerted.

When the retaining ring 141 is assembled into the valve main body 130, firstly, the valve body 3 having the seal member 140 attached thereto is pushed to a body 2 side, and the seal member 140 is pressed to the seal part 26 of the body 2 by so-called preloading, thereby forming the seal surface 144 on the seal member 140. Here, the magnitude of preloading is adjusted by the amount of fastening of the lid member 4, and pressing is performed with a distortion amount in a range of elastic deformation in which the seal member 140 is not plastically deformed. For example, when the seal member 140 is made of PTFE, the distortion amount is preferably on the order of approximately 3%. Here, the preloaded seal surface 144 of the seal member 140 serves as a sealing reference surface, and the seal member 140 is made close contact with fine asperities present on the surface of the seal part 26 for consistency.

Subsequently, by taking the seal surface 144 formed by preloading as a reference surface, loading required for sealing is applied by the spring member 6 to the seal member 140. In this case, since the seal member 140 is provided in a single seat structure, loading of pressure reception receives loading of pressure reception by main-body pressure-resistance inspection pressure. Also, as for a sealing pressure of the seal member 140 required for sealing the fluid, a pressing pressure approximately twice as large as the fluid pressure is preferably applied to the sealing area. The sealing pressure in this case is taken as being in an elastic region of the seal member 140. As loading when the spring member 6 is assembled, a friction loss and a seat friction margin are preferably added.

When the valve main body 130 is used, the seal member 140 is abraded with opening/closing operation of the valve body 3. However, with this seal member 140 pressed by the valve body 3 by the spring member to be pressed upward, the seal surface pressure is kept substantially constant.

Therefore, as the seal member 140 is abraded, the projecting amount of the upper stem 35 from the upper surface of the body 2 is increased, thereby allowing an abrasion status of the seal member 140 to be visually recognized from outside. Furthermore, for example, by measuring the projecting amount of the upper stem 35 or causing an appropriate position to be displayed on the upper stem 35, a replacement period of the seal member 140 can also be grasped.

To recover seal surface pressure between the seal member 140 and the seal part 26, the lid member 4 is screwed to be additionally tightened so as to press the seal member 140 to a seal part 26 side. Here, since a gap between the lid member 4 and the valve body 3 is ensured by the retaining ring 141, and initially-set loading can be recovered without excessively pressing the spring member 6 attached between the lid member 4 and the valve body 3.

Specific description is now made. In FIG. 8, immediately after assembling of the valve main body 130, the clearance C2, the attachment length of the spring member 6 between the lid member 4 and the valve body 3 in the axial direction at the time of set loading, becomes a predetermined length, and the seal member 140 is deformed by the resilient force of the spring member 6 to the axial direction by a predetermined amount of compression, thereby allowing a predetermined seal surface pressure to be exerted.

When the number of times of operation of the valve main body 130 is increased, the spring member 6 is about to extend in a resilient direction due to abrasion of the seal member 140 and so forth, thereby making it difficult to ensure the predetermined seal surface pressure. Thus, it is required to perform additional tightening by the lid member 4 for recovery to the predetermined seal surface pressure.

In the present embodiment, when additional tightening by the predetermined amount is performed, since movement of the valve body 3 in the direction of the lid member 4 is regulated, the amount of fastening of the lid member 4 is reflected directly as a seal surface pressure of the seal member 140 via the resilient force of the spring member 6, and the compression force can be controlled when the lid member 4 is fastened. With this, a constant compression amount of the spring member 6 can be ensured to keep the predetermined seal surface pressure. Even if the seal surface pressure is changed along a design value in accordance with the type, size, and so forth of the material of the seal member 140, recovery can be made to the predetermined seal surface pressure by additional tightening. Furthermore, since a full close contact when the spring member 6 is compressed can be avoided at the time of additional tightening, a weakening of the spring member 6 and a loss of the function of the spring member 6 caused thereby can be prevented, and seat leakage due to a decrease in seal surface pressure can be reliably avoided.

At the time of additional tightening, as being guided in a radial direction by the radial bearing function of the retaining ring 141, the valve body 3 smoothly moves in the axial center direction of the stem, and a uniform amount of deformation can be kept without adding unbalanced loading to the seal member 140.

In FIG. 11 to FIG. 13, a third embodiment of the rotary valve of the present invention is depicted.

In this valve main body 160, a seating face part 162 is provided on front and back surfaces (side surfaces) of a barrel part 171 of a body 161, and a protruding part 170 is formed on one side of this seating face part 162. The protruding part 170 is formed in a spherical-surface protruding shape. Via this protruding part 170, a grasp from the front and back surface sides of the body 161 by a cramp not depicted is regulated. This is described below in detail.

Normally, when piping is performed by connecting a valve such as a rotary valve by screwing, the valve is mounted on a fixed pipe (piping) in one case, and a piping is mounted on the fixed valve in another case. Generally speaking, when the valve is mounted on the fixed piping, a tool such as a spanner is hung on a hexagonal portion provided to a connecting part side where a pipe screw is machined for valve piping mounting, and the valve is rotated by this tool to be screwed in the piping. On the other hand, when the piping is mounted on the fixed valve, the tool is hung on a hexagonal portion on a connecting part side where a pipe screw is machined for valve piping mounting on a valve piping mounting side and, while rotation of the valve is prevented by this tool, the piping is screwed in the valve by another tool such as a wrench.

However, on the front and back surface (side surfaces) of the barrel portion of the valve, a cast blind seat for machining a cave hole for an exhaust hole and a mounting seat for mounting a switch for checking a valve open/close state are often provided. In actual operation, a screwing connection may be performed while these seats are grasped by a vise from both sides to fix the valve or cramped by a fastening tool. Furthermore, in these seats, the protruding dimension from the barrel portion of the valve is set to have a dimension required by design, and the seat surface is often formed as a flat surface, and therefore these seats tend to be misread as seats for grasping. On the other hand, even if these cast blind seat, switch-mounting seat, and so forth are not provided, with a cast seat left on the barrel portion, there is a high possibility of grasping this cast seat for piping connection.

Like these, when piping connection is performed by interposing the barrel portion of the valve, stress by screw fastening loading concentrates on a joint portion between the barrel portion and the hexagonal portion, and the body tends to be deformed. As a result, there is a possibility that the seal surface on an outflow/inflow port side of the body is deformed and the seal member of the valve body with respect to this seal surface cannot be correctly sealed, leading to an occurrence of seat leakage, external leakage, or the like of the fluid.

In contrast to this, in the present embodiment, the protruding part 170 is formed on the seating face part 162 on the side surface of the body 161 as described above. Thus, this protruding part 170 is visually recognized to confirm that this is not a seating part for cramping. With this, even if the seating face part 162 is tried to be erroneously cramped, the spherical surface of the protruding part 170 abuts on the flat surface of the cramp to cause the valve main body 160 to unstably move to rotate, resulting in unstable fastening. Thus, cramping to the seating face part 162 can be reliably prevented. Thus, piping connection can be made, while mounting of the tool to hexagonal surface parts 172 formed on both end sides of the barrel part 171 is guided and the seal surface is prevented from being deformed when these hexagonal surface parts 172 are each held by the tool and stress is applied to the barrel part at the time of fastening of piping.

Furthermore, the protruding part 170 can sufficiently exert its function as long as it has a subtle protruding dimension equivalent to a machining margin. Therefore, if the protruding part 170 is set to have a size removable by machining such as cutting, this protruding part 170 can be removed, and the seating face part 162 can be used as a blind seat or switch-mounting seat with ease. Therefore, the body 161 can be manufactured at low cost, and compactability of the valve main body 160 can be kept.

The seating face part 162 is provided on either one or both of the front and back surfaces of the body 161, and the protruding part 170 is formed at least one side on this seating face part 162. When the seating face part 162 is provided on both of the front and back surfaces of the barrel part 171, the protruding part 170 is formed on either one or both of these. At the time of formation, the protruding part 170 is desirably provided at a position shifted from the center of the seating face part 162 (not depicted). With this, for example, with the protruding part 170 formed at an asymmetrical position with respect to the seating face part 162 provided on the front and back surfaces of the barrel part 171, when the body 161 is about to be erroneously held by a cramp or the like, the state becomes more unstable, and grasping the seating face part 162 can be reliably inhibited.

The body 161 is provided with the seating face part 162 on both sides in advance, and the protruding part 170 is preferably formed at a bored position of the discharge port 12 of each of these seating face parts 162. In this case, when the discharge port 12 is bored in the seating face part 162 on any side of the body 161, the unnecessary protruding part 170 can be cut and removed simultaneously with boring operation. Thus, the operation of removing the protruding part 170 is not separately required, and the remaining protruding part 170 can also be left for the purpose of prevention of cramping. Although not depicted, the protruding part 170 is in a shape other than a spherical-surface protruding shape, and can be provided to have any of various shapes such as, for example, a cone shape or pointed spherical shape.

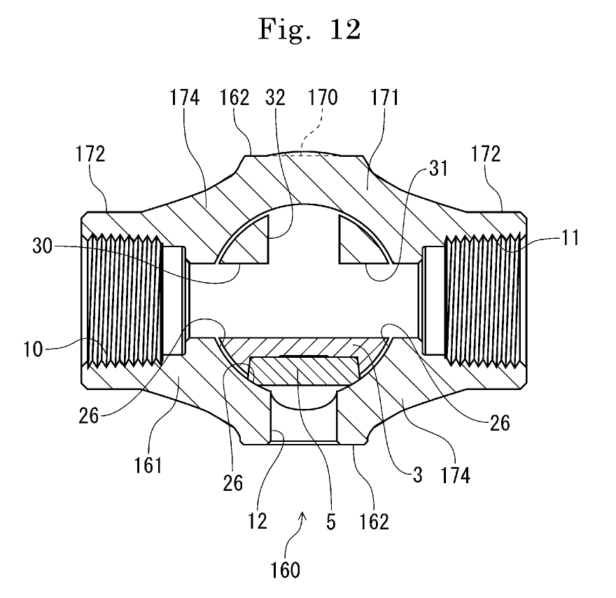

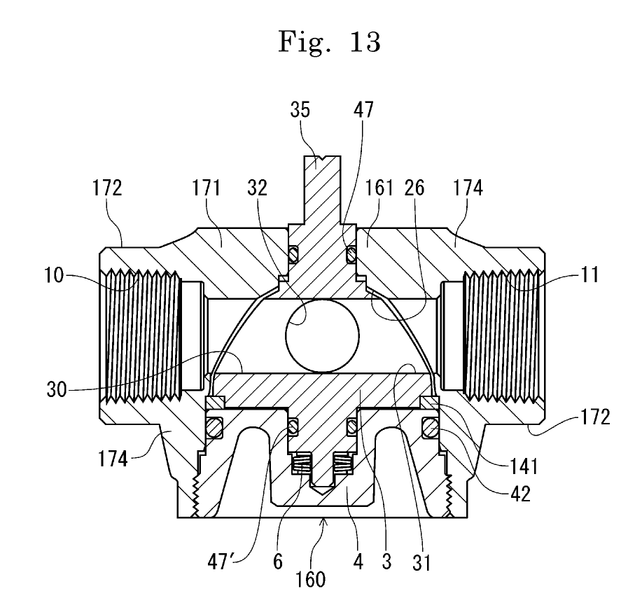

Furthermore, in the present embodiment, as depicted in FIG. 12 and FIG. 13, a tapered-shaped thick part 174 is provided from the barrel part 171 over the hexagonal surface parts 172. With formation of this thick part 174, compared with general valves having a depression between a barrel portion and hexagonal portions, strength between the barrel part 171 and the hexagonal surface part 172 is dramatically improved. Thus, concentration of stress by loading of fastening at the time of piping connection is reliably prevented, distortion of the seal part 26 due to deformation of the body 161 is prevented, and sealability after piping connection can be ensured.

Note that when the seating face part 162 is cramped erroneously by an operator, the pressing force of cramping concentrates on the protruding part 170, thereby causing the protruding part 170 to be deformed or causing an impression by a cramping tool such as a pipe wrench to be left. With this, it can be recognized that a cause of valve seat leakage is cramping of the seating face part 162.

### INDUSTRIAL APPLICABILITY

The rotary valve of the present invention can also be used as, other than a quick exhaust valve for a railway vehicle described above, for example, a two-way, three-way, four-way, multiway rotary valve and so forth, in technical fields as exemplarily listed below. That is, the present invention can also be used as: a flow-control-type rotary valve to be used for flow path switching in a heating medium (hot and chilled water) control piping system or the like of a heat exchanger; a rotary valve to be used for flow adjustment or opening/closing in bypass piping for steam or the like; various multiway valves to be used in conduit branching in a piping system for high-pressure water, oil, gas, air, or the like; various multiway valves for sanitary with easy disassembling and assembling, easy sterilization and flushing, and high maintenance capability; manual or automatic various multiway valves in an anti-disaster valve unit in a fire-extinguishing sprinkler facility to be used for opening/closing, drainage, testing, flow path switching, or the like; a valve configuring an entire or part of a freeze prevention tap or part of a conduit which requires non-freezing; part of a piping system to be used in a specially-equipped vehicle such as a tank lorry, sprinkler truck, or jet pack (particulate transport vehicle); part of a conduit of vapor piping, air-conditioning coolant piping, freezer coolant piping; part of air pressure or water pressure piping in a factory facility; part of a piping system in a sprinkler facility; part of a piping system in a sanitary facility; and so forth.

1-6. (canceled)

7. A rotary valve in which outflow/inflow ports and a discharge port are formed in a valve body accommodating part having a spherical surface part or a tapered surface part formed on part of an inner periphery in a body, a valve body is rotatably inserted from an opening which is open from the valve body accommodating part, a spherically-shaped surface part or a tapered-shaped surface part is formed on an outer periphery of this valve body at a position opposing the spherical surface part or the tapered surface part, a plurality of through ports communicating the outflow/inflow ports or the discharge port and an attachment groove opposing the outflow/inflow ports in a direction crossing these through ports are further formed, a seal member for closing the outflow/inflow ports or the discharge port is attached to this attachment groove, any one of the outflow/inflow ports or the discharge port is hermetically sealed and closed by the seal member when the opening is covered with a lid member, the outflow/inflow ports and the discharge port or the outflow/inflow ports are provided so as to be able to communicate mutually via the through ports, also a retaining ring is interposed between a lower inner circumferential surface, which is the opening of the valve body accommodating part, and a lower outer circumferential surface of the valve body, and this retaining ring is attached between the valve body and the lid member.

8. The rotary valve according to claim 7, wherein a spring member is attached between the lid member and the valve body, the seal member can be additionally tightened by the lid member covering the opening, and the seal member is provided so as to be able to be pressed on a seal surface of the body via the spring member.

9. The rotary valve according to claim 7, wherein the rotary valve is provided so that the outflow/inflow ports and the discharge port are connected to a conduit so as to allow a flow path of this conduit to be switched or allow a fluid to be discharged from the discharge port.

10. The rotary valve according to claim 7, wherein a seating face part is provided to one or both of front and back surfaces of the body, and a protruding part which regulates a grasp from the front and back surfaces of the body is formed on at least one side on this seating face part.

11. A quick exhaust valve for a railway vehicle, wherein an exhaust time for exhausting air from an automatic door opening/closing apparatus piping in case of emergency, security, or the like can be set constant by adjusting the discharge port area of the rotary valve according to claim 7 as appropriate.

12. The rotary valve according to claim 8, wherein the rotary valve is provided so that the outflow/inflow ports and the discharge port are connected to a conduit so as to allow a flow path of this conduit to be switched or allow a fluid to be discharged from the discharge port.

13. The rotary valve according to claim 8, wherein a seating face part is provided to one or both of front and back surfaces of the body, and a protruding part which regulates a grasp from the front and back surfaces of the body is formed on at least one side on this seating face part.

14. The rotary valve according to claim 9, wherein a seating face part is provided to one or both of front and back surfaces of the body, and a protruding part which regulates a grasp from the front and back surfaces of the body is formed on at least one side on this seating face part.

15. A quick exhaust valve for a railway vehicle, wherein an exhaust time for exhausting air from an automatic door opening/closing apparatus piping in case of emergency, security, or the like can be set constant by adjusting the discharge port area of the rotary valve according to claim 8 as appropriate.

16. A quick exhaust valve for a railway vehicle, wherein an exhaust time for exhausting air from an automatic door opening/closing apparatus piping in case of emergency, security, or the like can be set constant by adjusting the discharge port area of the rotary valve according to claim 9 as appropriate.

17. A quick exhaust valve for a railway vehicle, wherein an exhaust time for exhausting air from an automatic door opening/closing apparatus piping in case of emergency, security, or the like can be set constant by adjusting the discharge port area of the rotary valve according to claim 10 as appropriate.
